(19) United States
(12) Patent Application Publication
(10) Pub. No.: US 2019/0156446 A1
(43) Pub. Date: May 23, 2019

(54) METHOD FOR DELEGATING AND VERIFYING RIGHTS OVER A TUTEE BETWEEN A TUTOR AND A THIRD PARTY

(71) Applicant: IDEMIA FRANCE, Colombes (FR)

(72) Inventors: Cédric BARREAU, Colombes (FR); Alban FERAUD, Colombes (FR)

(21) Appl. No.: 15/738,566

(22) PCT Filed: Jun. 21, 2016
(86) PCT No.: PCT/FR2016/051514

§ 371 Date: Dec. 20, 2018

(30) Foreign Application Priority Data
Jun. 22, 2015 (FR) 1555720

(51) Int. Cl. G06Q 50/20; H04L 9/30; H04L 9/14; H04L 9/32

(52) U.S. Cl. CPC G06Q 50/205; H04L 9/30; G06Q 2220/00; H04L 9/3231; H04L 9/321; H04L 9/14

(57) ABSTRACT

A method of delegating and verifying rights that enables a tutor (10) to delegate rights over a tutee (20) to a third party (30). The method includes creating a delegation attestation (71) that includes a third party authorization (33) comprising the rights over the tutee (21) that are delegated to the third party (31) by the tutor (10). The method further includes storing the delegation attestation (71), and if not already present, storing an affiliation attestation (51) identifying a tutoring relationship between a tutor (10) and a tutee (20) comprising a tutor authorization (13) that includes the rights allocated to the tutor (10) over the tutee (20). There is also an associated verification method.

The present invention relates to defining and enforcing relationships that may exist between a tutor, a tutee, and at least one third party, and doing so in secure manner. More particularly, the present invention relates to a tutor delegating rights over a tutee to a third party.

In the present specification, the term “tutee” is used to mean a person not entitled to perform some formality on their own. Performing such a formality requires the oversight of a tutor. In the present specification, the term “tutor” means a person holding rights for the tutee and capable of performing such a formality in the name of the tutee or of authorizing the tutee to perform such a formality. So far as we are aware, when such a formality involves a tutee, there do not exist at present any means enabling the formality to be performed while taking account of the particular situation of the tutee, of the tutee's limited rights, and where appropriate, of the necessary intervention of the tutor.

The present invention remedies those various drawbacks and proposes establishing a delegation that enables the rights of the tutor to be transferred to a third party so that the third party is in a position to replace the tutor. A corresponding verification method is also proposed.

The invention provides a delegation method enabling a tutor to delegate rights over a tutee to a third party, comprising: creating a delegation attestation comprising: a third party authorization comprising the rights over the tutee that are delegated to the third party by the tutor, storing the delegation attestation, and if not already present, storing an affiliation attestation identifying a tutoring relationship between a tutor and a tutee comprising a tutor authorization comprising the rights allocated to the tutor over the tutee.

According to another characteristic, the method also comprises the following steps: producing an electronic guarantee of the integrity and the authenticity of the delegation attestation.

According to another characteristic, the electronic guarantee is a delegation seal produced by electronically signing the delegation attestation by means of tutor cryptographic material associated with the tutor, and the method further comprises the following step: storing the delegation seal.

According to another characteristic, the tutor cryptographic material comprises a tutor public key and a tutor private key, and the portion of the tutor cryptographic material used for producing the delegation seal comprises the tutor private key.

According to another characteristic, the delegation attestation further comprises a tutor attribute and/or a tutee attribute and/or a third party attribute.

According to another characteristic, the tutor is associated with tutor cryptographic material, and the tutor attribute comprises at least a portion of the tutor cryptographic material, and/or the tutee is associated with tutee cryptographic material and the tutee attribute comprises at least a portion of the tutee cryptographic material, and/or the third party is associated with third party cryptographic material and the third party attribute comprises at least a portion of the third party cryptographic material.

According to another characteristic, the tutor cryptographic material comprises a tutor public key and a tutor private key, and the portion of the tutor cryptographic material used for producing the delegation seal comprises the tutor private key.

According to another characteristic, the tutor cryptographic material comprises a tutor public key and a tutor private key, and the portion of the tutor cryptographic material comprised in the tutor attribute comprises the tutor public key, and/or the tutee cryptographic material comprises a tutee public key and a tutee private key, and the portion of the tutee cryptographic material comprised in the tutee attribute comprises the tutee public key, and/or the third party cryptographic material comprises a third party public key and a third party private key, and the portion of the third party cryptographic material comprised in the third party attribute comprises the third party public key.

According to another characteristic, the electronic signing step is conditional on supplying a tutor document and on authenticating the bearer of the tutor document by means of a PIN code associated with the tutor document, and/or by means of biometric identification, and/or by proving that the bearer knows a tutor attribute comprised in the affiliation attestation or in the delegation attestation.

According to another characteristic, the storage step(s) is/are performed: on a tutor document associated with the tutor, on a tutee document associated with the tutee, on a third party document associated with the third party, on a mass storage medium, on a network storage medium, or indeed distributed over a plurality of the above media.

According to another characteristic, the tutor document, the tutee document, and the third party document are electronic documents produced by an authority, the tutor electronic document storing the tutor cryptographic material, the tutee electronic document storing the tutee cryptographic material, and the third party electronic document stores the third party cryptographic material.

The invention also provides a delegation method, whereby a third party who has received a delegation of rights over a tutee by such a delegation method, delegates rights over a tutee to a secondary third party, comprising the following steps: creating a delegation attestation comprising: a secondary third party authorization comprising the rights over the tutee that are delegated to the secondary third party by the third party, storing the delegation attestation, if not already present, storing an affiliation attestation identifying a tutoring relationship between a tutor and a tutee comprising a tutor authorization comprising the rights allocated to the tutor over the tutee, and if not already present, storing delegation attestations identifying the successive delegations between the tutor and the third party.

The invention also provides an emancipation method, whereby a third party who has received a delegation by such a delegation method, emancipates a tutee, the emancipation method comprising: creating an emancipation attestation comprising: a tutee authorization comprising the rights emancipated to the tutee by the third party, storing the emancipation attestation, if not already present, storing an affiliation attestation identifying a tutoring relationship between a tutor and a tutee comprising a tutor authorization comprising the rights over the tutee that are allocated to the tutor, and if not already present, storing delegation attestations identifying the successive delegations between the tutor and the third party.

The invention also provides a verification method for verifying a delegation performed by the delegation method, the verification method comprising the following steps: reading the affiliation attestation, optionally checking the origin and the integrity of the affiliation attestation by verifying the associated electronic guarantee, reading the delegation attestation, optionally checking the origin and the integrity of the delegation attestation by verifying the associated electronic guarantee, and making use of the third party authorization.

According to another characteristic, checking the origin and the integrity of the affiliation attestation further comprises the following steps: reading the affiliation seal, checking the affiliation seal by means of at least a portion of the authority cryptographic material, and the checking of the origin and the integrity of the delegation attestation further comprises the following steps: reading at least a portion of the tutor cryptographic material, reading the delegation attestation, reading the delegation seal, and checking the delegation seal by means of at least a portion of the tutor cryptographic material.

According to another characteristic, the authority cryptographic material comprises an authority public key and an authority private key, and the portion of the authority cryptographic material used for checking the affiliation seal comprises the authority public key, and the tutor cryptographic material comprises a tutor public key and a tutor private key, and the portion of the tutor cryptographic material used for checking the delegation seal comprises the tutor public key.

According to another characteristic, the method further comprises at least one of the following steps: if a tutee attribute is comprised in the affiliation attestation or in the delegation attestation, optionally checking the authenticity of the tutee by proving that the tutee knows said tutee attribute, and if a third party attribute is comprised in the affiliation attestation or in the delegation attestation, optionally checking the authenticity of the third party by proving that the third party knows said third party attribute.

According to another characteristic, the method further comprises at least one of the following steps: if a portion of the tutee cryptographic material is comprised in the affiliation attestation or in the delegation attestation, optionally checking the authenticity of the tutee document by proving that it holds at least a portion of the tutee cryptographic material, and if a portion of the third party cryptographic material is comprised in the affiliation attestation or in the delegation attestation, optionally checking the authenticity of the third party document by proving that it holds at least a portion of the third party cryptographic material.

According to another characteristic, the method further comprises at least one of the following steps: if the tutee cryptographic material comprises a tutee public key and a tutee private key, and if said tutee public key is comprised in the affiliation attestation or in the delegation attestation, optionally checking the authenticity of the tutee electronic document by proving that it holds the tutee private key, by means of a challenge and response with said tutee public key, and if the third party cryptographic material comprises a third party public key and a third party private key, and if said third party public key is comprised in the affiliation attestation or in the delegation attestation, optionally checking the authenticity of the third party electronic document by proving that it holds the third party private key, by means of a challenge and response with said third party public key.

The invention also provides an electronic document comprising an affiliation attestation and/or an associated electronic guarantee, and/or a delegation attestation and/or an associated electronic guarantee.

According to another characteristic, the electronic document comprises a tutor attribute or a tutee attribute or a third party attribute, in order to form respectively a tutor electronic document, or a tutee electronic document, or a third party electronic document.

Other characteristics, details, and advantages of the invention appear more clearly from the following detailed description given by way of indication and with reference to the drawings, in which:

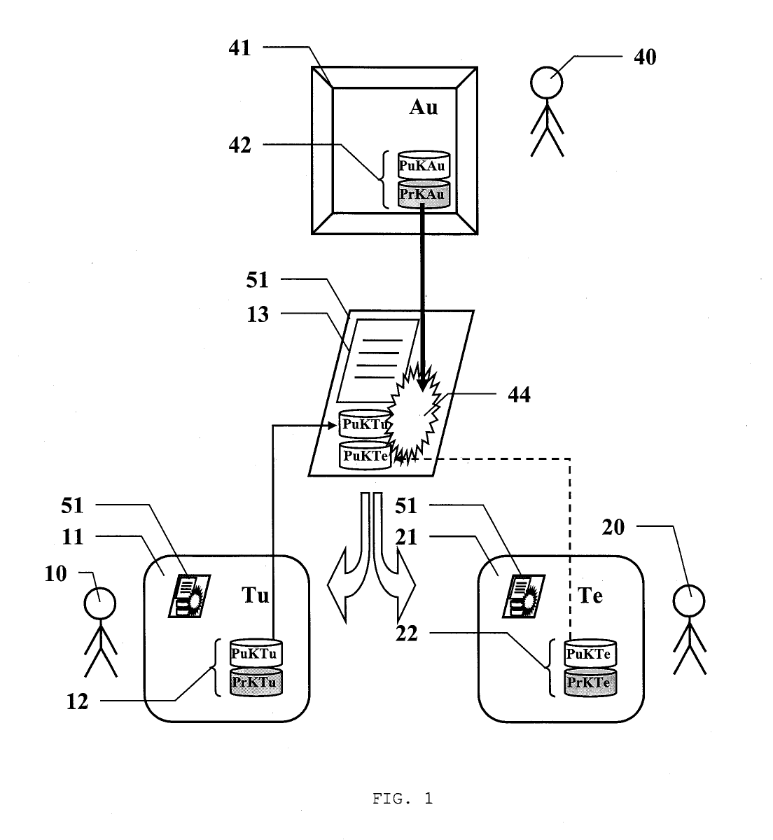

FIG. 1 shows an affiliation between a tutor electronic document and a tutee electronic document;

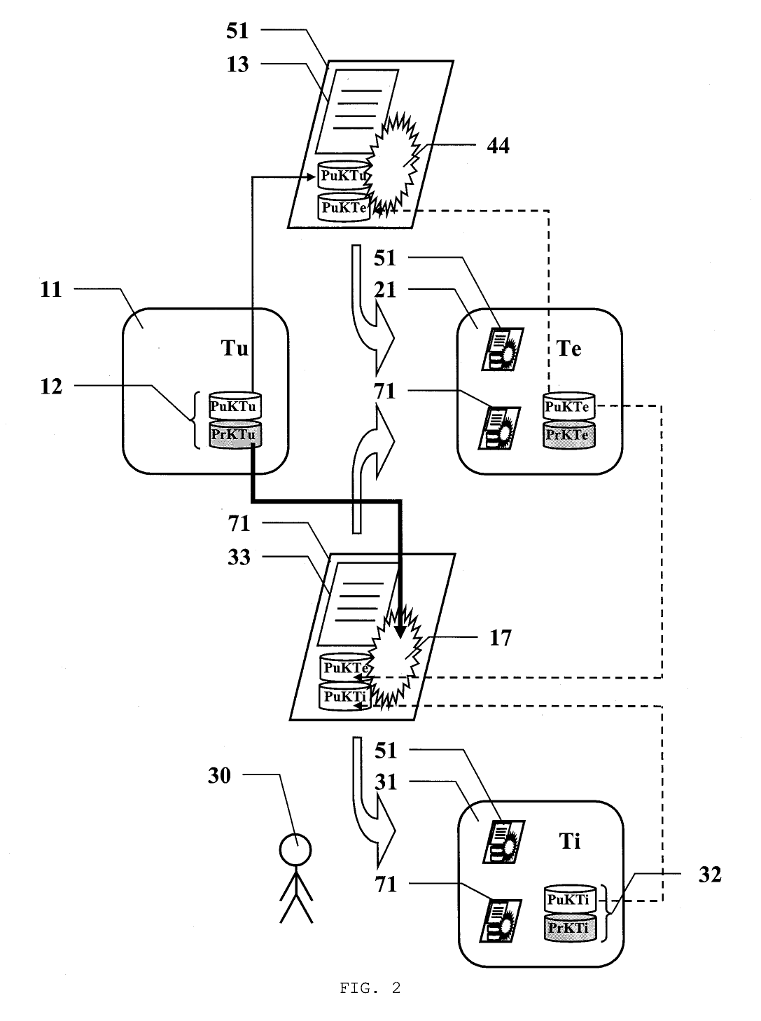

FIG. 2 shows a delegation of rights over a tutee performed by a tutor to the benefit of a third party;

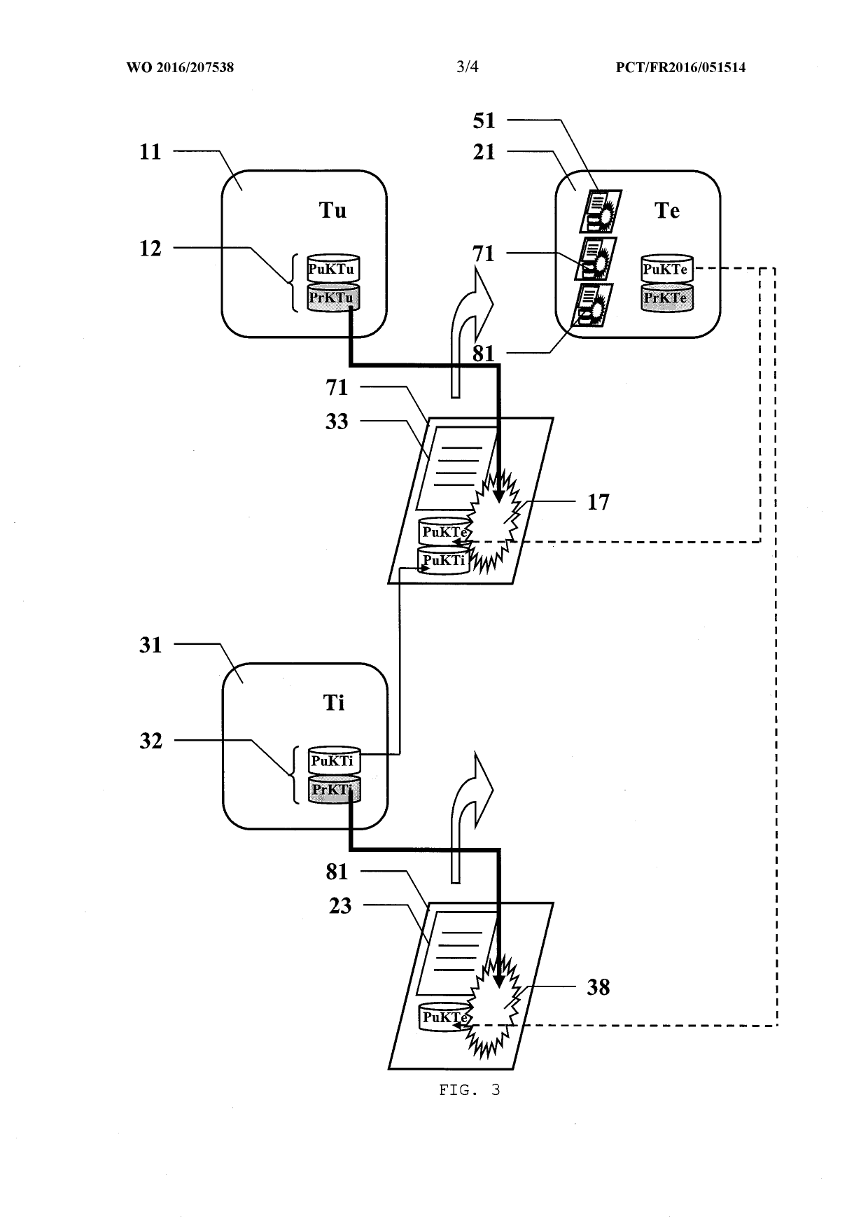

FIG. 3 shows an emancipation benefiting a tutee and performed by a delegated third party; and

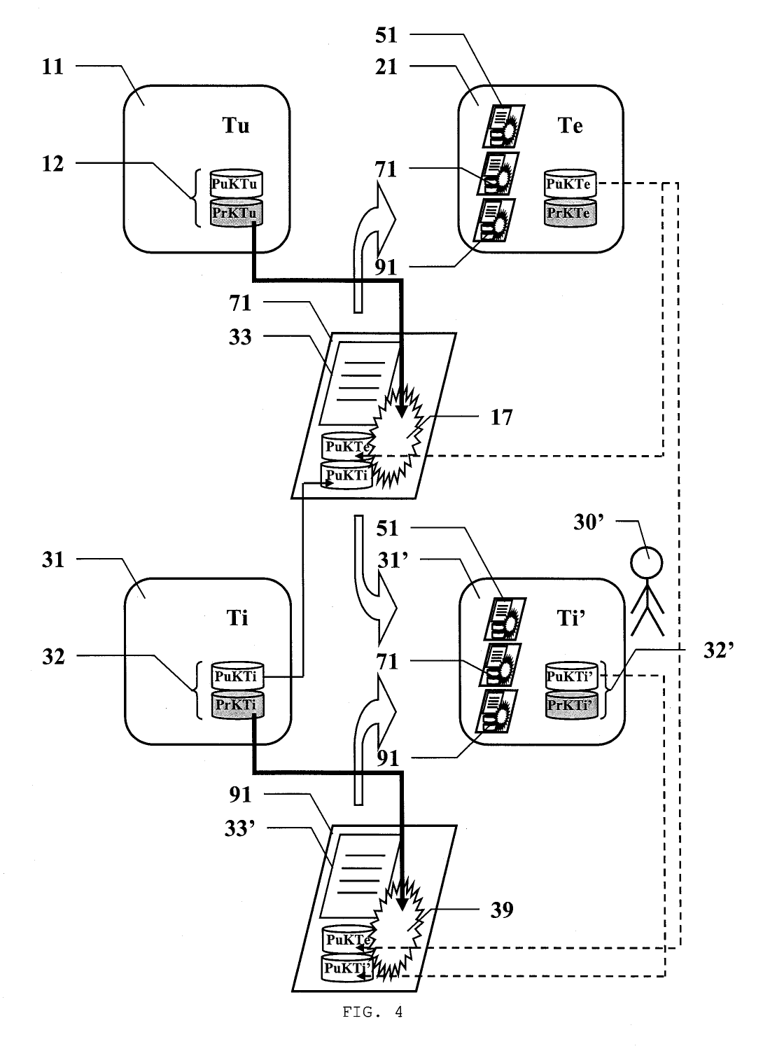

FIG. 4 shows a delegation of rights over a tutee performed by a delegated third party to the benefit of a secondary third party.

It is appropriate to specify the definitions of the terms used in the present specification.

The tutee is a person, having limited particular rights in that the person cannot perform on their own certain formalities, but can perform them under the oversight of a tutor. By way of example, the tutee is a person presenting limited legal capacity. The person may be a minor, a person under guardianship, or a person under curatorship. By way of example, the tutee may be a subordinate having accesses/authorizations/rights over a system that are defined under the oversight of a hierarchical superior. The term “tutee” should be understood in the present specification as covering any of these terms equally well.

By extension, the term “tutee” is used in the present specification for qualifying elements associated with the tutee person. This applies to a tutee document, to a tutee electronic document, to tutee cryptographic material, to a tutee cryptographic pair, or indeed to a tutee public/private key.

The tutor is a person having authority over the tutee for allowing the tutee, under the oversight of the tutor, to perform operations that the tutee cannot perform alone. By way of example, the tutor may be a person having the capacity to represent the tutee in the legal sense. The person may be a parent or a tutor of a minor, a guardian of a person under guardianship, or indeed a curator for a person under curatorship. By way of example, the tutor may be a hierarchical superior. The term “tutor” in the present specification is used to cover any of these terms equally well.

By extension, the term “tutor” is used in the present specification to qualify elements associated with the person of the tutor. This may apply to a tutor document, to a tutor electronic document, to tutor cryptographic material, to a tutor cryptographic pair, or indeed to a tutor public/private key.

A third party is a person. The person is suitable for receiving a delegation from a tutor or from another third party. This person may exercise the particular rights of the tutor. It is also possible for certain conditions to apply to the third party depending on circumstances, for example concerning majority or capacity.

By extension, the term “third party” is used in the present specification to qualify elements associated with the third party. This applies in particular to a third party document, to a third party electronic document, to third party cryptographic material, to a third party cryptographic pair, or indeed to a third party public/private key.

A document is a medium suitable for storing information. It may be a sheet of paper, a card, a booklet, a plastics card, a badge, a magnetic strip, suitable for receiving an inscription that may be written, drawn, printed, etched, embossed, visible or hidden, a bar code, a QR code, etc. . . . . A document is advantageously issued by an authority. In order to guarantee its origin, its authenticity, its provenance, and its integrity, a document advantageously comprises an authentication and/or security device: a stamp, a certification, a hologram, or any means allowing the issuing authority to provide a signature in order to guarantee origin and integrity.

One particular type of document is an electronic document. An electronic document 11, 21, 31, 31′ comprises information storage means, such as a memory, that is made secure by a microcircuit or chip. Its form may vary and comprise a microcircuit card such as a bank card or a SIM card, a USB key, a memory card, such as an SD card, an RFID tag, etc. An electronic document thus comprises a storage zone that is accessible only by means of dialog with the microcircuit, which may apply any type of access control to the stored data. An electronic document 11, 21, 31, 31′ is thus suitable for storing cryptographic material 12, 22, 32, 32′. The microcircuit gives the electronic document the ability to process, enabling calculations to be performed, comparisons to be made, and indeed tests of consistency or authenticity to be undertaken, or else enabling encryption to be performed or an electronic signature to be provided.

Such an electronic document 11, 21, 31, 31′ may be used as a telephone card, a social security card, a bank card, a driver's license, an identity document such as an electronic identity card, or a travel document, such as an electronic passport. Such an electronic document is usually associated with a person or carrier, enabling that person to transport personal data in secure manner, typically relying on cryptographic and/or biometric material. The data and the material may enable the bearer of the electronic document to state their rights.

Thus, an identity document enables a person to prove their identity by indicating their civil status with certainty. A social security card may contain a person's medical dossier together with that person's insurance rights. A bank card may enable a person to perform operations, payments, withdrawals, etc. on one or more bank accounts. A travel document may enable a person to prove their identity and allow that person to travel by making it possible to perform inspection formalities on crossing a frontier.

In the present description, several parties hold cryptographic material 12, 22, 32, 32′, 42, e.g. comprising respective cryptographic pairs 12, 22, 32, 32′, 42. A cryptographic pair is personal and associated with one of the parties (authority, tutor, tutee, third party, . . . ) and is stored in secure manner, e.g. in an electronic document associated with the party. In known manner, the cryptographic pair may comprise asymmetric cryptographic material with a public key PuKxx and a private key PrKxx that are associated with each other, where xx is a code designating the party: Au=authority, Tu=tutor, Te=tutee, Ti=third party, Ti′=secondary third party. By way of example, such a cryptographic pair 12, 22, 32, 32′, 42 may be of any of the following types: RSA, two keys on elliptic curves, ECC, or the equivalent.

Such a cryptographic pair 12, 22, 32, 32′, 42 makes several kinds of processing possible. A basic property is that a signature made by means of the private key PrKxx can be verified by means of the associated public key PuKxx, but without that revealing the private key PrKxx, nor enabling it to be deduced. The public key PuKxx may be distributed to recipients, who are then in a position to use the public key PuKxx to verify a signature made using the private key PrKxx, but without that giving them the ability to make such a signature.

An electronic document serves advantageously to store a private key PrKxx, and to sign it by means of the private key, without disclosing or externalizing said private key PrKxx, which remains specific to its holder and under the exclusive control of its holder.

This enables a party to be authenticated, by proving that said party is in possession of a private key PrKxx specific to that party, but without disclosing the private key PrKxx. This is typically performed by means of an exchange referred to as a challenge and response. An inspector, in possession of the public key PuKxx of a person, challenges a claimant by submitting random test data. The claimant signs the test data by using the private key PrKxx and returns the signed data to the inspector. The inspector verifies the returned signed data by means of the public key PuKxx. If the received signature and the initial test data match, in that using the associated public key on the received signature produces data that can be correctly verified with the test data, then the claimant does indeed possess the private key PrKxx and can reasonably be taken to be the person in question. This serves to authenticate a person.

It is also possible to use such a cryptographic pair 12, 22, 32, 32′, 42 for electronically signing data by making a seal 16, 17, 38, 39, 44 serving to ensure the integrity of the transmitted data. Under such circumstances, an issuer transmits data and accompanies that data with an electronic seal 16, 17, 38, 39, 44 made by using the issuer's private key PrKxx to sign at least a portion or a digest of the data. The receiver, who has the issuer's public key PuKxx, verifies the seal by means of said public key PuKxx and compares the result with the portion or digest of the data. If they are identical, then the seal was indeed made using the private key PrK associated with the public key PuK, thus attesting that the data does indeed have the issuer as its origin and also attesting the integrity of the data, which cannot have been modified since it was signed.

All of the cryptographic pairs used by the invention are preexisting. Thus an important advantage of the invention is that it does not need new cryptographic material.

Following these general considerations, there follows a description of a delegation method that enables a tutor to delegate at least some of the tutor's rights over a tutee to a third party. Delegation requires a prior affiliation in order to identify a tutoring relationship between a tutor and a tutee.

Thus, for reference purposes, there follows a description of an affiliation method that constitutes the subject matter of another application by the same Applicant.

The delegation method is also associated with a verification method.

The first need relates to defining the tutoring relationships associating a tutor 10 with a tutee 20, and the associated rights, in order to identify said tutoring relationship. For this purpose, and as shown in FIG. 1, an affiliation is established between a tutor 10 and a tutee 20 by means of an affiliation method. Such an affiliation is identified by an affiliation attestation 51 that comprises at least a tutor authorization 13 with a list of the rights allocated to the tutor 10 over the tutee 20. Such an affiliation attestation 51 may comprise any durable medium or recording means.

It may be a handwritten or printed letter, a microfilm, a sound recording listing said rights, etc. After being created, such an affiliation attestation 51 is recorder or stored so as to be capable of being consulted subsequently in order to be used and allow a tutor or a tutee to assert at least one of their rights.

In an advantageous implementation, an affiliation attestation is advantageously digital in order to enable it to be stored and processed by computer.

In order to make an affiliation attestation 51 secure, a guarantee of integrity and authenticity is advantageously produced. Such a guarantee is advantageously affixed or associated with the affiliation attestation 51 in that it resumes at least an element of the affiliation attestation 51 in order to be connected therewith. Such a guarantee is advantageously difficult to reproduce and capable of withstanding any modification in order to constitute a guarantee that is reliable. In addition, the guarantee is advantageously provided by the authority 40 that issues the affiliation attestation 51 in order to authenticate the origin of the affiliation attestation 51 and its integrity.

Such a guarantee may take various forms, from the very simple to the very complex, depending on the desired level of security. Thus, a guarantee may be a write access right held by the authority 40 over the medium or a portion of the medium in which the affiliation attestation is stored. Sharing write access with an organization performing verification can serve to guarantee the authenticity and the integrity of the affiliation attestation 51. A guarantee may also be any security device suitable for being inspected by a verifying organization. By way of example, an electronic guarantee of integrity may be a checksum. Other implementations of such a guarantee and the associated verification techniques are possible and limited only by the imagination of the person skilled in the art.

It is advantageously possible to use said guarantee in order to verify it and thus confirm the authenticity and the integrity of the affiliation attestation 51.

In a preferred implementation, the guarantee is electronic.

In another preferred implementation, the electronic guarantee is an affiliation seal 44 produced by electronically signing the affiliation attestation 51 using authority cryptographic material 42 associated with an authority 40. The authority 40 may be a trusted third party, and in particular circumstances, the authority 40 may issue the affiliation attestation 51.

After producing such an affiliation seal 44 by electronic signature, the affiliation seal 44 is advantageously stored. It can be stored in any location, together with or separately from the affiliation attestation 51. In one particular implementation, it may be incorporated in the affiliation attestation 51. The only constraint is that said affiliation seal 44 can be reread whenever necessary, e.g. in order to verify the affiliation attestation 51.

According to a characteristic, the affiliation attestation 51 also comprises a tutor attribute and/or a tutee attribute. The term “attribute” is used herein to mean an element, recording, piece of data, a possession, etc., relating to or associated with the respective tutor and/or tutee in person and serving to establish a link with that person. By way of example, it may be that person's name, social security number, identity photograph, preferred color, a PIN code, biometric data, cryptographic means, etc.

In an implementation, the tutor 10 is associated with tutor cryptographic material 12. Under such circumstances, the tutor attribute may be made up of at least a portion of the tutor cryptographic material 12. Likewise, the tutee 20 may be associated with tutee cryptographic material 22. Under such circumstances, the tutee attribute comprises at least a portion of the tutee cryptographic material 22.

As mentioned above, the affiliation attestation 51 and an affiliation seal 44, if any, are capable of being stored. The storage may be performed on any medium, so long as it is capable of being reread for subsequent use. Thus, the storage may be performed on a tutor document 11 associated with the tutor 10, on a tutee document 21 associated with the tutee 20, and more generally on any mass storage medium, such as a local hard disk, a memory card, a USB key, a microcircuit card, a telephone, etc., or indeed on such a mass storage medium that is accessible by a communications network, and referred to as a “network storage” medium. Each of the stored elements may be stored in full on only one of the media, or it may be divided into a plurality of portions, each portion being stored on a storage medium selected from amongst the above-mentioned media.

In a preferred implementation, the tutor 10 is associated with a tutor electronic document 11 and the tutee 20 is associated with a tutee electronic document 21. Under such circumstances, and as shown in FIG. 1, an affiliation is established in electronic manner between the tutor 10 represented by the tutor electronic document 11 and the tutee 20 represented by the tutee electronic document 21, by performing an affiliation method.

In a preferred implementation, the tutor cryptographic material comprises a tutor cryptographic pair 12 comprising a tutor public key PuKTu and a tutor private key PrKTu. In a preferred implementation, the tutee cryptographic material comprises a tutee cryptographic pair 22 comprising a tutee public key PuKTe and a tutee private key PrKTe. The tutor cryptographic pair 12 and the tutee cryptographic pair 22 are typically stored respectively on the tutor electronic document 11 and on the tutee electronic document 21.

The tutor and tutee electronic documents 11 and 21 are produced by an authority 40. The authority 40 has authority cryptographic material 42 comprising an authority cryptographic pair 42 comprising an authority public key PuKAu and an authority private key PrKAu. This authority cryptographic pair 42 is typically stored in a highly secure “super” electronic document 41, also referred to as a hardware security module (HSM) serving as a cryptographic safe. The entire security of the system of the invention relies on keeping secret the authority cryptographic material, and in particular the authority private key PrKAu.

The term “authority” 40 is used herein to designate the organization in charge of issuing electronic documents 11, 21. Thus, for a travel document, the authority is typically a government, or in practice an industrial document signer (DS) working on behalf of and under the control of the government and to which the government subcontracts the technicalities of fabricating electronic documents.

As in the above-described general situation, the affiliation method comprises a first step of creating an affiliation attestation 51. This affiliation attestation, which identifies the tutoring relationship, comprises a tutor authorization 13. It may also comprise a tutor attribute, e.g. in the form of the tutor public key PuKTu. The tutor authorization 13 is a file containing the rights of the tutor 10 over the tutee 20. This tutor authorization 13 defines the tutor(s), the tutee(s), and the rights of the tutor over the tutee: what the tutor may do for and/or on behalf of the tutee, what the tutor may authorize the tutee with or without the presence of the tutor, what the tutor may potentially delegate to a third party, any conditions on exercising these rights and any limits of these rights, whether in space or in time.

The definition of these rights is linked to the application. Thus, in a system for accessing a secure database, the rights may comprise the zones that are accessible or not accessible to the tutee, and the kinds of access: read only, write, delete, and possible changes to those zones and kinds of access that the tutor may authorize. Concerning a travel document for a child who is a minor (tutee), the rights of the parent (tutor) are defined by law and may possibly be changed by legal judgment.

During a second step, the entire content of the affiliation attestation 51 is subjected to an electronic signature by applying the authority private key PrKAu to at least a portion or digest coming from each of its constituent parts. This produces an affiliation seal 44 guaranteeing the origin (the authority 40) and the integrity of the affiliation attestation 51.

During a third step, the affiliation attestation 51 and the affiliation seal 44 are stored, together or separately, e.g. in the tutor electronic document 11, in the tutee electronic document 21, or in both of them.

In an implementation, it is also possible to store the affiliation attestation 51 and the affiliation seal 44 in part in the tutor electronic document 11 and in part in the tutee electronic document 21. Under such circumstances, recovering these two elements, e.g. for verification purposes, requires both the tutor electronic document 11 and the tutee electronic document 21. This is applicable when a formality that requires the affiliation attestation 51 and the affiliation seal 44 also requires the joint presence of the tutor electronic document 11 and of the tutee electronic document 21.

In another implementation, the affiliation attestation 51 and/or the affiliation seal 44 may also be stored, where appropriate in part, in at least one other medium. Advantageously, if it is necessary to read one or the other, it is appropriate that said medium can be present or at least remotely accessible in order to enable said reading.

FIG. 1 shows an implementation of the affiliation method. An affiliation attestation 51 is created that comprises a tutor authorization 13 containing the rights of the tutor 10. The tutor electronic document 11 always (as indicated by a continuous line) supplies (as indicated by a thin arrow) the tutor public key PuKTu. The tutee electronic document 21 optionally (as indicated by a dashed line) supplies (as indicated by a thin arrow) the tutee public key PuKTe. The authority electronic safe 41 signs (as indicated by a thick arrow) the affiliation attestation 51 by means of the authority private key PrKAu and produces an affiliation seal 44. The signed affiliation attestation 51 and the affiliation seal 44 are stored (as indicated by a broad white arrow), e.g. in the tutee electronic document 21 and/or in the tutor electronic document 11.

The tutor public key PuKTu is useful for performing verification operations, as described below. In this context, the tutor public key PuKTu is comprised in the affiliation attestation 51.

For another function, as described below, of verifying the authenticity of the tutee electronic document 21 or of the tutor electronic document 11, it may be useful to have the tutee public key PuKTe or the tutor public key PuKTu as the case may be. Thus, optionally, the affiliation attestation 51 may also comprise the tutee public key PuKTe.

The affiliation attestation 51 is the highest level attestation, from which most of the other operations depend. It is signed by the authority 40, which can be done only by the authority, and it requires the presence of the electronic document(s) 11, 21 or of the medium (a) on which the affiliation attestation 51 is stored. Once created, an affiliation may be verified, typically prior to performing a formality. A verification method depends on the form and the content of the affiliation. Thus, an affiliation that does not comprise any associated guarantee is difficult to verify other than by inspecting its appearance.

An affiliation that comprises a guarantee, which may be electronic or otherwise, can be verified. The way in which verification is performed depends on the form of the guarantee.

A method of verifying an affiliation performed by the above-described method comprises the following steps. A first step consists in reading the affiliation attestation 51 from the medium on which it is stored. Thereafter, a verification is performed by inspecting the associated guarantee.

When the guarantee is an affiliation seal 44, another step consists in reading the affiliation seal 44 from the medium (a) on which it is stored. During a second step, the origin and the integrity of the affiliation attestation 51 are verified by means of the affiliation seal 44. This verification is performed by means of the authority cryptographic material 42.

If this verification is successful, the authenticity and the integrity of the affiliation attestation 51 are accepted and its content, comprising the tutor authorization 13, may be used in complete security.

The affiliation method and the affiliation verification method under the control of the authority cryptographic pair 42 ensure that the affiliation attestation 51 has a high level of legitimacy, since it is guaranteed by the authority 40.

Depending on the implementation, the form of the inspection may change. When a tutor attribute is available, the authenticity of the tutor 10 can be inspected by giving the tutor the possibility, e.g. by dialog via a man/machine interface, to prove that the tutor knows the tutor attribute contained in the affiliation attestation 51.

This proof may be undertaken in various ways and this knowledge should be understood very broadly. Such knowledge may be knowledge properly speaking or possession. It may be direct or indirect. It may also be partial or complete.

Direct knowledge extends to knowledge that the holder holds directly. Thus, a holder knows directly his or her own name and date of birth. A holder naturally has a facial image that can be compared with an identity photo or indeed a biometric print for which the holder can give or give again a sample or an image. Direct knowledge also covers a password or a PIN number. Indirect knowledge or holding/possession extends to a visual or magnetic storage medium that can be presented during the inspection. It may thus be a bar code, a photo, or a graphical representation, a password, or cryptographic material.

The inspection is then successful if the holder claiming to be the tutor 10 is capable of responding to the request for proof concerning the tutor attribute by presenting directly or indirectly a response that is satisfactory in terms of the expected tutor attribute.

If the tutor attribute exists in a portion of the tutor cryptographic material 12 contained in the affiliation attestation 51, the authenticity of the tutor document 11 can be inspected by proving that the tutor document 11 holds at least a portion of the tutor cryptographic material 12.

If the tutor cryptographic material 12 comprises a tutor public key PuKTu and a tutor private key PrKTu, the authenticity of the tutor electronic document 11 is checked by proving that it holds the tutor private key PrKTu. This is typically done by challenge and response, as described above, using the tutor public key PuKTu, if that tutor public key PuKTu is available, e.g. contained in the affiliation attestation 51.

The tutor 10, with the accompanying tutor electronic document 11, is thus in a position to be able to prove holding the tutor private key PrKTu that corresponds to the tutor public key PuKTu as extracted from the affiliation attestation 51, thereby authenticating the tutor.

This may typically be done during an inspection formality if the tutor 10 and the tutor electronic document 11 are both present and involved in said formality.

Depending on what is available, the inspection may be of some other form. When a tutee attribute is available, the authenticity of the tutee 20 can be inspected by giving the tutee the possibility, e.g. via a dialog using a man/machine interface, to prove that the tutee knows the tutee attribute contained in the affiliation attestation 51.

As for the tutor, this knowledge should be understood in very broad manner.

The inspection is then successful if the bearer claiming to be the tutee 20 is capable of responding to the request for proof concerning the tutee attribute by presenting directly or indirectly a response that is satisfactory in terms of the expected tutee attribute.

If the tutee attribute consists in a portion of the tutee cryptographic material 22 contained in the affiliation attestation 51, the authenticity of the tutee document 21 can be inspected by proving that the tutee document 21 holds at least a part of the tutee cryptographic material 22.

If the tutee cryptographic material 22 comprises a tutee public key PuKTe and a tutee private key PrKTe, the authenticity of the tutee electronic document 21 is checked by proving that it holds the tutee private key PrKTe. This is typically done by challenge and response, as described above, using the tutee public key PuKTe, if said tutee public key PuKTe is available, e.g. contained in the affiliation attestation 51.

The tutee 20, with the tutee electronic document 21, is thus in a position to be able to prove holding the tutee private key PrKTe that corresponds to the tutee public key PuKTe as extracted from the affiliation attestation 51, thereby authenticating the tutee.

This may typically be done during an inspection formality if the tutee 20 and the tutee electronic document 21 are both present and involved in said formality.

Affiliation is an essential first brick of the edifice. It may be used for various operations: emancipation and delegation.

A delegation to a third party 30 enables a tutor 10 to delegate at least one right over a tutee 20 by transferring that right to a third party 30 so as to enable the third party 30 to take the place of the tutor 10, in that the right enables the tutee 20 to perform a formality that would normally be performable only in the presence of the tutor 10, and to do so in the presence of a third party 30, comprising when in the absence of the tutor 10. Under such circumstances, the need for the actual presence of the tutor 10 is replaced by the presence of the third party 30 and by a delegation attestation 71 specifying which right the tutor 10 authorizes the third party 30 to execute on the tutor's behalf and under what limits in terms of time and space.

For this purpose, a delegation method comprises a step of creating a delegation attestation 71. Such a delegation attestation 71 comprises a third party authorization 33 having the rights that have been emancipated to the third party 30 by the tutor 10.

Like the affiliation attestation 51 and in similar manner, the delegation attestation 71 is advantageously stored so as to be capable of being subsequently found in order to be inspected and used.

In order to be capable of being used and/or inspected, the delegation attestation 71 requires an affiliation attestation 51 in order to define the link between the tutor 10 and the tutee 20. It is assumed that such an affiliation attestation 51 is already in existence and has already been stored. If not, it could be created and/or stored on the same occasion as the delegation.

Just like the affiliation attestation 51, a guarantee of integrity and authenticity can be produced in association with the delegation attestation 71. This guarantee may be electronic.

In a preferred implementation, the electronic guarantee is a delegation seal 17 produced by electronically signing the delegation attestation 71 using tutor cryptographic material 12 associated with the tutor 10.

After producing such a delegation seal 17 by electronic signature, the delegation seal 17 is advantageously stored. It may be stored in any location, together with or separately from the delegation attestation 71. In a particular implementation, it may be incorporated in the delegation attestation 71. The only constraint is that said delegation seal 17 must be capable of being reread when needed, e.g. in order to perform a method of verifying the delegation attestation 71.

According to a characteristic, the delegation attestation 71 further comprises a tutor attribute and/or a tutee attribute and/or a third party attribute. The term “attribute” is used herein to designate an element, a recording, data, a possession, etc. relating to or associated with the person respectively of the tutor and/or the tutee and/or the third party, and enabling a link to be established with that person.

In an implementation, the tutor 10 is associated with tutor cryptographic material 12. Under such circumstances, the tutor attribute may be made up by at least a portion of the tutor cryptographic material 12. Likewise, the tutee 20 may be associated with tutee cryptographic material 22. Under such circumstances, the tutee attribute may comprise at least a portion of the tutee cryptographic material 22. Likewise, the third party 20 may be associated with third party cryptographic material 32. Under such circumstances, the third party attribute comprises at least a portion of the third party cryptographic material 32.

As mentioned above both the delegation attestation 71 and any delegation seal 17 can be stored. This storage may be performed on any medium, so long as it makes it possible for it to be reread for subsequent use. The storage may thus be on a tutor document 11 associated with the tutor 10, on a tutee document 21 associated with the tutee 20, or on a third party document 31 associated with the third party 30, and more generally it may be on any mass storage medium or indeed on such a mass storage medium that is accessible via a communications network, and that is referred to as a “network storage” medium. Each of the stored elements may be stored in full on only one of those media or it may be divided into a plurality of portions, with each portion being stored on a storage medium selected from amongst the above media.

In a preferred implementation, the tutor 10 is associated with a tutor electronic document 11, the tutee 20 is associated with a tutee electronic document 21, and the third party 30 is associated with a third party electronic document 31.

Under such circumstances, and as shown in FIG. 2, a delegation operation is performed and implemented electronically by a delegation method. As in the above-described general situation, the delegation method comprises a first step of creating a delegation attestation 71 that comprises a third party authorization 33. Like the tutor authorization 13, the third party authorization 33 is a file containing the rights delegated to the third party 30 by the tutor 10. It defines what the third party 30 can do for the tutee 20 instead of and replacing the tutor 10, comprising when in the absence of the tutor 10. The third party authorization 33 also comprises any conditions for exercising these rights and any limits on these rights, both in space and in time.

Logically, the rights as delegated in this way to the third party 30 cannot go beyond the rights that are actually available to the tutor 10. The third party authorization 33 is therefore advantageously a subset of the tutor authorization 13. This necessary relationship can be verified when creating the third party authorization 33 during the delegation method. Alternatively, this relationship may be verified at any time by one of the verification methods, e.g. prior to exercising one of the rights.

During a second step, at least a portion or digest of the content of the delegation attestation 71 is subjected to electronic signature by means of the tutor private key PrKTu. This produces a delegation seal 17 guaranteeing the origin (the tutor 10) and the integrity of the delegation attestation 61.

During a third step, the delegation attestation 71 and the delegation seal 17 are stored, together or separately, advantageously in the tutee electronic document 21, in the third party electronic document 31, or in both of them. Storage in the tutor electronic document 11 (or in some other electronic document) is also possible, but in practice is found to be of little use since the purpose of a delegation is to enable the tutor 10 to be absent. In this example, the use of a network medium for performing this storage is advantageous, insofar as said network is accessible during use, verification, or operation of the delegation attestation 71.

In order to enable the delegation attestation 71 and the delegation seal 17 to be verified, a copy is needed of the affiliation attestation 51 and of the associated affiliation seal 44 produced by the above-described affiliation method. Thus, if they are not already present in the tutee electronic document 21 or in the third party electronic document 31, the affiliation attestation 51 and the affiliation seal 44 are advantageously stored in the tutee electronic document 21, in the third party electronic document 31, or in both of them.

In an implementation, it is also possible to store the affiliation attestation 51 and the affiliation seal 44, and indeed the delegation attestation 71 and the delegation seal 17, in part in the tutee electronic document 21 and in part in the third party electronic document 31. Under such circumstances, recovery, e.g. for verification purposes, requires both the tutee electronic document 21 and the third party electronic document 31. This is applicable when the formality that requires the affiliation attestation 51 and the affiliation seal 44, and also the delegation attestation 71 and the delegation seal 17, also requires the joint presence of the tutee 20 and of the third party 30, and thus the joint presence of the tutee electronic document 21 and of the third party electronic document 31.

Also alternatively, any alternative storage medium may be used insofar as it is accessible when required. In that it generally accompanies the tutee 20, the tutee electronic document 21 is a medium that is advantageously available and present. Likewise, in that it generally accompanies the third party 30, the third party electronic document 31 is a medium that is advantageously available and present.

FIG. 2 shows an implementation of the delegation method. A delegation attestation 71 is created that comprises a third party authorization 33 containing the rights delegated to the third party 30. The tutee electronic document 21 optionally (as indicated by a dashed line) supplies (as indicated by a thin arrow) the tutee public key PuKTe. The third party electronic document 31 optionally (as indicated by a dashed line) supplies (as indicated by a thin arrow) the third party public key PuKTi. The tutor electronic document 11 signs (as indicated by a thick arrow) the delegation attestation 71 by means of the tutor private key PrKTu and produces a delegation seal 17. The signed delegation attestation 71+17 is stored (as indicated by a broad white arrow) in the tutee electronic document 21, in the third party electronic document 31, or in both of them. The signed affiliation attestation 51+44, made during the affiliation method, is also stored in the tutee electronic document 21, in the third party electronic document 31, or in both of them.

By means of the tutor electronic document 11, the tutor 10 acts during the delegation method as an authority. Nevertheless, the tutor's security level and legitimacy are conferred on the tutor by the authority 40. Furthermore, the presence of the affiliation attestation 51 in addition to the delegation attestation 71 is required. A stack of attestations 51, 71 is thus present, thereby complementing one another and conferring security coming from the highest level: the authority 40.

Unlike affiliation which requires a signature by the authority and can therefore be performed only in the premises of the authority 40 and using its heavyweight cryptographic infrastructure 41, the delegation makes use of a signature by the tutor 10. Creating a delegation attestation 71 requires the tutor electronic document 11 for the step of signing by means of the tutor private key PrKTu. It also requires the tutee electronic document 21 and/or the third party electronic document 31 for the step of storing the delegation attestation 71 and the delegation seal 17, and where appropriate for the step of copying/storing the affiliation attestation 51 and the affiliation seal 44. Nevertheless, these electronic documents 11, 21, and 31 are portable and independent. Thus, the tutor electronic document 11 can perform the signature step independently. As a result, and most advantageously, the delegation method can thus be performed by means of very lightweight infrastructure. Thus, for example, a person having an electronic document reader, i.e.: an SD card reader, a USB reader, a microcircuit card reader, etc.; available on a personal computer or the equivalent together with an appropriate simple and standard software application can perform the delegation method, e.g. from home, providing that person has the tutor electronic document 11 and the tutee electronic document 21 and/or the third party electronic document 31. There is thus no need for a connection to a secure network, nor for the use of a trusted third party, nor for an organization authorized by the authority 40.

For another above-mentioned function of verifying the authenticity of the tutee electronic document 21, or of the third party electronic document 31, it may be useful to have available the tutee public key PuKTe or the third party public key PuKTi, as the case may be. Thus, optionally, and in particular when it is not comprised in the affiliation attestation 51, the delegation attestation 71 may also comprise the tutee public key PuKTe. Likewise, and optionally, the delegation attestation 71 may also comprise the third party public key PuKTi.

In exchange for the simplicity of the means for implementing the delegation method, the signature by the tutor 10 becomes an important step of the delegation method and enables rights that are devolved on the tutor 10 by the authority 40 itself to be transmitted. It is thus appropriate to ensure that the signature step is properly performed, preferably in the presence of, and at least with the agreement of, the tutor 10 and not solely in the presence of the tutor electronic document 11, which might be accessible to the tutee, for example. Thus, according to an advantageous optional characteristic, the electronic signature step of the delegation method is conditional on authenticating the bearer of the tutor electronic document 11. The purpose of such authentication is to ensure the presence, and above all the consent, of the tutor 10 to the delegation, both in principle and in detail. This authentication of the bearer of the tutor electronic document 11 may be performed by any means. Thus, by way of example, it may be required to input a secret code, a code of the PIN type associated with the tutor electronic document 11. As an alternative or in addition, a biometric identification check may be used to authenticate the tutor.

A priori, it is not necessary to obtain the consent of the tutee 20 for a delegation. Furthermore, depending on circumstances, the tutee 20 is not necessarily in a position to give such consent. Nevertheless, a step of obtaining such consent can easily be comprised in a delegation method, e.g. using a step of authenticating the tutee 20, by verifying a PIN code and/or by a biometric test.

Obtaining the consent of the third party 30 for receiving the delegation can easily be comprised in a delegation method, e.g. by means of a step of authenticating the third party, by verifying a PIN code and/or by a biometric test.

Once it has been created, a delegation can be verified, typically prior to performing a formality that requires a right to be exercised by the third party 30. Before any use of a delegated right, it is preferable to verify the delegation.

A method of verifying a delegation depends on the form and the content of the delegation.

A delegation comprising an optionally electronic guarantee can be verified. The way in which verification is performed depends on the form of the guarantee.

A method of verifying a delegation performed by the above-described delegation method comprises the following steps. A first step consists in reading the affiliation attestation 51 from the medium on which it has been stored. During a second step, the origin and the integrity of the affiliation attestation 51 are verified by checking the associated electronic guarantee. A third step consists in reading the delegation attestation 71 from the medium on which it has been stored. During a fourth step, the origin and the integrity of the delegation attestation 71 are verified by checking the associated electronic guarantee.

When the affiliation guarantee is an affiliation seal 44, another step consists in reading the affiliation seal 44 from the medium (a) on which it has been stored. As above in the affiliation method, during another step, the origin and the integrity of the affiliation attestation 51 are verified by means of the affiliation seal 44. This verification is performed using the authority cryptographic material 42.

When the delegation guarantee is a delegation seal 17, another step consists in reading the delegation seal 17 from the medium (a) on which it has been stored. During another step, the origin and the integrity of the delegation attestation 71 are verified by means of the delegation seal 17. This verification is performed by means of the tutor cryptographic material 12.

If both of these verifications are successful, the authenticity and the integrity of the delegation attestation 71 are deemed to be successful and its content, comprised in the delegation attestation authorization 33, can be used in full confidence for applying the rights delegated to the third party 30.

In an implementation, the authority cryptographic material 42 comprises an authority public key PuKAu and an authority private key PrKAu, and the affiliation seal 44 was made using the authority private key PrKAu. Thus, the authority public key PuKAu corresponding to the authority private key PrKAu used for signing the affiliation attestation 51 is necessary and makes it possible to verify the affiliation seal 44. These two first steps substantially reproduce the steps of the method of verifying the affiliation, since the legitimacy of the delegation is certified by the affiliation attestation 51. This step also makes it possible to extract the tutor public key PuKTu of the affiliation attestation 51 with assurance concerning its origin and its integrity.

In an implementation, the tutor cryptographic material 12 comprises the tutor public key PuKTu and a tutor private key PrKTu, and the delegation seal 17 was made by means of the tutor private key PrKTu. Thus, the origin and the integrity of the delegation attestation 71 is verified by means of the delegation seal 17. For this purpose, the tutor public key PuKTu, corresponding to the tutor private key PrKTu used for signing the delegation attestation 17 is necessary and serves to verify the delegation seal 17.

Verifying the delegation seal 17 by means of the tutor public key PuKTu makes it possible to be sure about the origin of the delegation attestation 71, which was indeed created under the control of the tutor 10, and to be sure about the integrity of its content, which has remained unchanged since it was issued. It is thus possible to be confident about the content of the delegation attestation 71 and in particular the content of the third party authorization 33, which can then be used in order to apply the rights delegated to the third party 30.

The tutor public key PuKTu for the delegation verifier is available since the tutor public key PuKTu is supplied by the affiliation attestation 51, and certified by the authority 40, and since this key has previously been extracted.

The delegation method and the delegation verification method under the control of the tutor cryptographic pair 12 serve to give the delegation attestation 71 high level legitimacy since it is guaranteed by the tutor 10, with the legitimacy of the tutor 10 itself being guaranteed via the affiliation under the control of the authority cryptographic pair 42, by the authority 40.

As before, when a tutor attribute is available in the content of the affiliation attestation 51, such as for example tutor cryptographic material 12, such as the tutor public key PuKTu, for example, it is optionally possible to check the authenticity of the tutor 10. The term “optionally” refers to the situation in which the tutor 10 and/or the tutor electronic document 11 are actually present during the formality. Specifically, the delegation may be intended to enable the tutor 10 to be absent.

Depending on the implementation, the inspection may change form. When a tutor attribute is available, the authenticity of the tutor 10 can be checked by giving the tutor the possibility of proving that he or she knows the tutor attribute contained in the affiliation attestation 51, e.g. by dialog using a man/machine interface.

This proof may be obtained in various ways and this knowledge should be understood very broadly.

The inspection is then validated if the bearer who claims to be the tutor 10 is capable of responding to the request for proof concerning the tutor attribute by presenting directly or indirectly a response that is satisfactory in terms of the expected tutor attribute.

If the tutor attribute consists in a portion of the tutor cryptographic material 12, the authenticity of the tutor 10 and of the tutor document 11 can be checked by proving that the tutor document 11 holds at least a portion of the tutor cryptographic material 12.

If the tutor cryptographic material 12 comprises the tutor public key PuKTu and the tutor private key PrKTu, then the authenticity of the tutor 10 and of the tutor electronic document 11 can be checked by proving that it holds the tutor private key PrKTu. This is typically performed by challenge and response, as described above, using the tutor public key PuKTu, assuming said tutor public key PuKTu is available, e.g. contained in the affiliation attestation 51 or in the emancipation attestation 61.

The tutor 10 together with the tutor electronic document 11 is thus in a position to prove possession of the tutor private key PrKTu corresponding to the tutor public key PuKTu as extracted from the affiliation attestation 51, thereby authenticating the tutor.

In analogous manner, depending on the implementation, if a tutee attribute, e.g. tutee cryptographic material 22, such as for example the tutee public key PuKTe is available, e.g. because it is contained in the affiliation attestation 51 and/or in the delegation attestation 71 and/or on any medium that is accessible during the verification, it is possible to proceed in analogous manner to verify the authenticity of the tutee 20, and thus of the tutee electronic document 21, if any.

Depending on the implementation, the inspection may change form. When a tutee attribute is available, the authenticity of the tutee 20 can be inspected by giving the tutee the possibility of proving that he or she knows the tutee attribute, e.g. by means of a man/machine interface.

This proof may be obtained in various ways and this knowledge should be understood very broadly.

The inspection is then validated if the bearer claiming to be the tutee 20 is capable of responding to the request for proof concerning the tutee attribute by presenting directly or indirectly a response that is satisfactory in terms of the expected tutee attribute.

If the tutee attribute consists in a portion of the tutee cryptographic material 22, the authenticity of the tutee 20 and of the tutee document 21 can be checked by proving that the tutee document 21 holds at least a portion of the tutee cryptographic material 22.

If the tutee cryptographic material 22 comprises a tutee public key PuKTe and a tutee private key PrKTe, the authenticity of the tutee 20 and of the tutee electronic document 21 is checked by proving that the tutee holds the tutee private key PrKTe. This is typically performed by challenge and response, as described above, with the tutee public key PuKTe, if the tutee public key PuKTe is available, e.g. contained in the affiliation attestation 51 or in the delegation attestation 71.

The tutee 20 together with the tutee electronic document 21 is thus in a position to prove that the tutee holds the tutee private key PrKTe corresponding to the tutee public key PuKTe extracted from the affiliation attestation 51 or from the delegation attestation 71, thereby authenticating the tutee.

In analogous manner, depending on the implementation, if a third party attribute, e.g. third party cryptographic material 32, such as for example the third party public key PuKTi is available, e.g. because it is contained in the affiliation attestation 51 and/or in the delegation attestation 71 and/or on any medium accessible during verification, it is possible in analogous manner to check the authenticity of the third party 30, and thus of the third party electronic document 31, if any.

Depending on the implementation, checking may change form. When a third party attribute is available, the authenticity of the third party 30 can be checked by giving the third party the possibility of proving that he or she knows the third party attribute, e.g. by a dialog by means of a man/machine interface.

This proof may be achieved in various ways and this knowledge should be understood very broadly.

The inspection is then validated if the bearer claiming to be the third party 30 is capable of responding to the request for proof concerning the third party attribute by presenting directly or indirectly a response that is satisfactory in terms of the expected third party attribute.

If the third party attribute consists in a portion of the third party cryptographic material 32, the authenticity of the third party 30 and of the third party document 31 can be checked by proving that the third party document 31 holds at least a portion of the third party cryptographic material 32.

If the third party cryptographic material 32 comprises a third party public key PuKTi and a third party private key PrKTi, the authenticity of the third party 30 and of the third party electronic document 31 is checked by proving that it holds the third party private key PrKTi. This is typically performed by challenge and response, as described above, using the third party public key PuKTi if the third party public key PuKTi is available, e.g. contained in the affiliation attestation 51 or in the delegation attestation 71.

The third party 30 together with the third party electronic document 31 is thus in a position to prove that the third party holds the third party private key PrKTi corresponding to the third party public key PuKTi extracted from the affiliation attestation 51 or from the delegation attestation 71, thereby authenticating the third party.

An illustrative example of a travel document system involves a child who is a minor (tutee 20) authorized to cross a frontier only when accompanied by one of his or her parents (tutor 10), and a third party 30 receives by delegation at least some of the rights of a parent. An affiliation attestation 51 specifies a parent. Nevertheless, it is awkward and inappropriate for the authority 40 to modify or to create an affiliation attestation 51 that is solely for use by a delegated third party 30. Thus, a delegation attestation 71 is used, which states that the third party 30 is authorized to replace the parent 10 of the tutee 20, e.g. for the formality of crossing the frontier. The inspection at the frontier of the child's electronic document 21 on its own would indicate that the child is not entitled to cross the frontier. The third party authorization 33 establishes the right for the third party 30 to take the place of the parent (tutor 10) in order to accompany the child (tutee 20) when crossing the frontier. The delegation attestation 71 read by the inspector from the electronic document 21 of the child 20 and/or from the electronic document 31 of the third party 30 makes it possible to determine whether a parent 10 has delegated authority to the third party 30, and the affiliation attestation 51 proves that the parent 10 is personally authorized by the authority 40 to delegate that right.

In a first implementation, a delegation makes it possible to allow a third party 30 to take the place of the tutor 10. The presence of the third party 30 can then replace the presence of the tutor 10. The third party 30 is authorized to act as the affiliated tutor 10 and can thus, by being present, enable the tutee 20 to perform a formality that requires the presence of a tutor 10.

In another implementation, shown in FIG. 3, and if the delegation to the third party 30 comprises such a right, the third party 30 may in turn emancipate the tutee 20. Everything takes place substantially as for a “direct” emancipation performed by the tutor 10, the third party 30 taking the place of the tutor 10. Such an emancipation is described in greater detail in another application by the Applicant.

As shown in FIG. 3, there exists a previously-made delegation attestation 71 using a third party authorization 33 to define the right that the tutor 10 delegates to the third party 30. If these rights comprise the right to emancipate the tutee 20, the third party 30 can issue an emancipation attestation 81. Like a “direct” emancipation attestation made by a tutor 10, the emancipation attestation 81 comprises a tutee authorization 23 defining the right that the third party 30 emancipates to the tutee 20. Thereafter, the third party 30, by means of the third party electronic document 31, signs the emancipation attestation 81 using the third party private key PrKTi in order to make an emancipation seal 38. The emancipation attestation 81 and the emancipation seal 38 are stored on the tutee electronic document 21, for example.

The step of signature by the third party 30 is advantageously subjected to authentication (PIN, biometrics, etc.) of the third party 30. In order to enable the third party 30 to prove having authority to perform such emancipation, the delegation attestation 71 and the seal 17 are also stored on the tutee electronic document 21, for example. In order to enable the tutor 10 to prove that the tutor does indeed have authority to make such a delegation, the affiliation attestation 51 and the affiliation seal 44 are also stored on the tutee electronic document 21, for example. The tutee electronic document 21 thus contains a stack of attestations making it possible to work back to the authority 40 and serving to guarantee the content of the rights emancipated to the tutee 20 so that the tutee 20 can use them.

The verification of a right during a formality then comprises a cascade of verifications on all of the attestations in this stack.

In another implementation, shown in FIG. 4, and if the delegation to the third party 30 comprises such a right, the third party 30 can in turn make a delegation to a secondary third party 30′. Everything takes place substantially as for the “direct” delegation made by the tutor 10 to the third party 30 as shown in FIG. 2, the third party 30 then taking the place of the tutor 10 while the secondary third party 30′ takes the place of the third party 30. As shown in FIG. 4, there exists a previously-made delegation attestation 71 using a third party authorization 33 to define the rights that the tutor 10 delegates to the third party 30. If these rights comprise the right to delegate once more to another third party 30′, referred to as the “secondary” third party 30′, the third party 30 and where appropriate the third party electronic document 31 can issue a delegation attestation 91. Like the “direct” delegation attestation 71, the delegation attestation 91 comprises a secondary third party authorization 33′ defining the right that the third party 30 delegates to the secondary third party 30′.

In an implementation, the tutee public key PuKTe and the secondary third party public key PuKTi′ may also be comprised.

Thereafter, the third party 30 uses the third party electronic document 31 to sign the delegation attestation 91 by means of the third party private key PrKTi to make a delegation seal 39. The delegation attestation 91 and the delegation seal 38 are stored by way of example in the tutee electronic document 21 and/or the secondary third party electronic document 31′ and/or indeed on any medium.

The step of signature by the third party 30 is advantageously subjected to authentication (PIN, biometrics, etc.) of the third party 30. In order to be able to prove that the third party 30 does indeed have the authority to make such a delegation, the delegation attestation 71 and the delegation seal 17 are also stored by way of example in the tutee electronic document 21 and/or in the secondary third party electronic document 31′ and/or indeed, in any medium. In order to make it possible to prove that the tutor 10 does indeed have the authority to make such a delegation, the affiliation attestation 51 and the affiliation seal 44 are also stored, by way of example, in the tutee electronic document 21 and/or in the secondary third party electronic document 30′ and/or indeed, in any medium. The tutee electronic document 21 and/or the secondary third party electronic document 31′ and/or the other medium thus contains a stack of attestations making it possible to work back to the authority 40 and thus guarantee the content of the rights delegated to the secondary third party 30′, so that the tutee 20 can make use of them.

During a formality, a right is then verified by verifying in cascade all of this stack of attestations.

If the secondary third party 30′ receives the right to delegate, a new delegation accompanied by a new level of attestation can be made, and so on.

Logically, when transferring a right, by direct emancipation or by delegation to a second or nth rank, the rights that are transferred cannot exceed the rights actually available to the transferer. Thus, any transferred authorization is advantageously a subset of the transferring authorization. This necessary relationship can be verified when creating the transferred authorization during the creation method: emancipation or delegation. Alternatively, this relationship may be verified at any moment by one of the verification methods, e.g. prior to exercising any one of the rights.

1. A delegation method enabling a tutor to delegate rights over a tutee to a third party, the method comprising:
creating a delegation attestation comprising:
a third party authorization comprising the rights over the tutee that are delegated to the third party by the tutor;
storing the delegation attestation; and
if not already present, storing an affiliation attestation identifying a tutoring relationship between a tutor and a tutee comprising a tutor authorization comprising the rights allocated to the tutor over the tutee.

2. A delegation method according to claim 1, further comprising:
producing an electronic guarantee of the integrity and the authenticity of the delegation attestation.

3. A delegation method according to claim 2, wherein the electronic guarantee is a delegation seal produced by electronically signing the delegation attestation by means of tutor cryptographic material associated with the tutor, and wherein the method further comprises:
storing the delegation seal.

4. A delegation method according to claim 3, wherein the tutor cryptographic material comprises a tutor public key and a tutor private key, and wherein the portion of the tutor cryptographic material used for producing the delegation seal comprises the tutor private key.

5. A delegation method according to claim 1, wherein the delegation attestation further comprises a tutor attribute or a tutee attribute or a third party attribute.

6. A delegation method according to claim 5, wherein the tutor is associated with tutor cryptographic material, and the tutor attribute comprises at least a portion of the tutor cryptographic material, or the tutee is associated with tutee cryptographic material and the tutee attribute comprises at least a portion of the tutee cryptographic material, or the third party is associated with third party cryptographic material and the third party attribute comprises at least a portion of the third party cryptographic material.

7. A delegation method according to claim 6, wherein the tutor cryptographic material comprises a tutor public key and a tutor private key, and the portion of the tutor cryptographic material used for producing the delegation seal comprises the tutor private key.

8. A delegation method according to claim 6, wherein the tutor cryptographic material comprises a tutor public key and a tutor private key, and the portion of the tutor cryptographic material comprised in the tutor attribute comprises the tutor public key, or the tutee cryptographic material comprises a tutee public key and a tutee private key, and the portion of the tutee cryptographic material comprised in the tutee attribute comprises the tutee public key, or the third party cryptographic material comprises a third party public key and a third party private key, and the portion of the third party cryptographic material comprised in the third party attribute comprises the third party public key.

9. A delegation method according to claim 3, wherein the electronically signing is conditional on supplying a tutor document and on authenticating the bearer of the tutor document by means of a PIN code associated with the tutor document, or by means of biometric identification, or by proving that the bearer knows a tutor attribute comprised in the affiliation attestation or in the delegation attestation.

10. A delegation method according to claim 1, wherein the storing is performed:
on a tutor document associated with the tutor;
on a tutee document associated with the tutee;
on a third party document associated with the third party;
on a mass storage medium;
on a network storage medium; or
distributed over a plurality of the above media.

11. A delegation method according to claim 10, wherein the tutor document, the tutee document, and the third party document are electronic documents produced by an authority, wherein the tutor electronic document stores the tutor cryptographic material, wherein the tutee electronic document stores the tutee cryptographic material, and wherein the third party electronic document stores the third party cryptographic material.

12. A delegation method, whereby a third party who has received a delegation of rights over a tutee by a delegation method according to claim 1, delegates rights over a tutee to a secondary third party, the method comprising:
creating a second delegation attestation comprising:
a secondary third party authorization comprising the rights over the tutee that are delegated to the secondary third party by the third party;
storing the second delegation attestation;
if not already present, storing a second affiliation attestation identifying a tutoring relationship between a tutor and a tutee comprising a tutor authorization comprising the rights allocated to the tutor over the tutee; and
if not already present, storing the delegation attestations identifying the successive delegations between the tutor and the third party.

13. An emancipation method, whereby a third party who has received a delegation by a delegation method according to claim 1, emancipates a tutee, the emancipation method comprising:
creating an emancipation attestation comprising:
a tutee authorization comprising the rights emancipated to the tutee by the third party;
storing the emancipation attestation;
if not already present, storing a second affiliation attestation identifying a tutoring relationship between a tutor and a tutee comprising a tutor authorization comprising the rights over the tutee that are allocated to the tutor; and
if not already present, storing delegation attestations identifying the successive delegations between the tutor and the third party.

14. A verification method for verifying a delegation performed by the delegation method according to claim 3, the verification method comprising:
reading the affiliation attestation;
optionally checking the origin and the integrity of the affiliation attestation by verifying the associated electronic guarantee;
reading the delegation attestation;
optionally checking the origin and the integrity of the delegation attestation by verifying the associated electronic guarantee; and
making use of the third party authorization.

15. A verification method according to claim 14, wherein checking the origin and the integrity of the affiliation attestation further comprises:
reading an affiliation seal;
checking the affiliation seal by means of at least a portion of an authority cryptographic material, and
wherein the checking of the origin and the integrity of the delegation attestation further comprises:
reading at least a portion of the tutor cryptographic material;
reading the delegation attestation;
reading the delegation seal; and
checking the delegation seal by means of at least a portion of the tutor cryptographic material.

16. A verification method according to claim 15, wherein the authority cryptographic material comprises an authority public key and an authority private key, and wherein the portion of the authority cryptographic material used for checking the affiliation seal comprises the authority public key, and wherein the tutor cryptographic material comprises a tutor public key, and a tutor private key, and wherein the portion of the tutor cryptographic material used for checking the delegation seal comprises the tutor public key.

17. A verification method according to claim 14, further comprising at least one of the following:
if a tutee attribute is comprised in the affiliation attestation or in the delegation attestation, optionally checking the authenticity of the tutee by proving that the tutee knows said tutee attribute; and
if a third party attribute is comprised in the affiliation attestation or in the delegation attestation, optionally checking the authenticity of the third party by proving that the third party knows said third party attribute.

18. A verification method according to claim 14, further comprising at least one of the following:
if a portion of the tutee cryptographic material is comprised in the affiliation attestation or in the delegation attestation, optionally checking the authenticity of the tutee document by proving that the tutee document holds at least a portion of the tutee cryptographic material; and
if a portion of the third party cryptographic material is comprised in the affiliation attestation or in the delegation attestation, optionally checking the authenticity of the third party document by proving that the third party document holds at least a portion of the third party cryptographic material.

19. A verification method according to claim 18, further comprising at least one of the following:
if the tutee cryptographic material comprises a tutee public key and a tutee private key, and if said tutee public key is comprised in the affiliation attestation or in the delegation attestation, optionally checking the authenticity of the tutee document by proving that the tutee document holds the tutee private key, by means of a challenge and response with said tutee public key; and
if the third party cryptographic material comprises a third party public key and a third party private key, and if said third party public key is comprised in the affiliation attestation or in the delegation attestation, optionally checking the authenticity of the third party document by proving that the third party document holds the third party private key, by means of a challenge and response with said third party public key.

20. An electronic document comprising an affiliation attestation and/or an associated electronic guarantee, and/or a delegation attestation in accordance with claim 1.

21. An electronic document according to claim 20, wherein the delegation attestation further comprises a tutor attribute or a tutee attribute or a third party attribute, in order to form respectively a tutor electronic document, or a tutee electronic document, or a third party electronic document.
